(19) United States
(12) Patent Application Publication
(10) Pub. No.: US 2016/0078185 A1
(43) Pub. Date: Mar. 17, 2016

(54) SYSTEM AND METHOD FOR VERIFICATION OF PHARMACEUTICAL DRUGS PRESCRIPTION AND COSTS

(71) Applicant: ADVANCED MEDICAL STRATEGIES, LLC, Lynnfield, MA (US)

(72) Inventors: Peter BORANS, North Reading, MA (US); Stacy BORANS, Chalfont, PA (US)

(21) Appl. No.: 14/851,598

(22) Filed: Sep. 11, 2015

Related U.S. Application Data
(60) Provisional application No. 62/049,621, filed on Sep. 12, 2014.

(51) Int. Cl. G06F 19/00

(52) U.S. Cl. CPC G06F 19/345; G06F 19/326; G06F 19/328

(57) ABSTRACT

A system and method of generating for determining appropriateness of a pharmaceutical prescription includes receiving, at a remote server, input data from a client device, the input data comprising at least one of a tradename of a pharmaceutical, a generic name of the pharmaceutical, drug category, drug sub category, or diagnosis data; searching, using a pharmaceutical clinical and expense module, a pharmaceutical usage/financial database (PUFD) to identify relevant data based on the input data; generating, using the pharmaceutical clinical and expense module, output data based, at least in part, on the identified relevant data; and transmitting the output data to the client device.

### CROSS-REFERENCE TO RELATED APPLICATION

This application claims the benefit of U.S. Provisional Patent Application Ser. No. 62/049,621, filed on Sep. 12, 2014, the entire disclosure of which is incorporated herein fully by reference.

### FIELD

The present disclosure relates to the field of pharmaceutical usage, pharmaceutical cost approximation, screening pharmaceuticals in claims, and/or underwriting pharmaceutical cost projections.

### BACKGROUND

Pharmaceuticals are prescribed for many medical treatments and/or procedures. Unfortunately, it is often very difficult for insurance professionals to check for medical appropriateness of a pharmaceutical prescription for a particular diagnosis. Additionally, it is often very difficult for insurance professionals to verify the reasonableness of the charges/costs associated with pharmaceuticals.

### BRIEF DESCRIPTION OF THE DRAWINGS

FIG. 1 depicts exemplary system architecture illustrating one or more client devices bi-directionally communicating with one or more network servers via network, consistent with non-limiting embodiments of the present disclosure.

FIG. 2 depicts an exemplary embodiment of a network server in accordance with non-limiting embodiments of the present disclosure.

FIG. 3 depicts an exemplary embodiment of a healthcare diagnosis/financial database in accordance with non-limiting embodiments of the present disclosure.

FIG. 4 depicts a flowchart of an exemplary method of providing healthcare diagnosis/financial data to a user at a client device using the network server, in accordance with non-limiting embodiments of the present disclosure.

FIG. 5 depicts one exemplary user interface generated by the network server in accordance with non-limiting embodiments of the present disclosure.

FIG. 6 depicts one exemplary output data generated by the network server which may be transmitted to and received at a client device, in accordance with non-limiting embodiments of the present disclosure.

FIG. 7 depicts one exemplary approved indication data generated by the network server which may be transmitted to and received at a client device, in accordance with non-limiting embodiments of the present disclosure.

FIG. 8 depicts one exemplary off-label indication data generated by the network server which may be transmitted to and received at a client device, in accordance with non-limiting embodiments of the present disclosure.

FIG. 9 depicts a flowchart of an exemplary method of obtaining data at a client device to generate a stop-loss re-insurance policy premium and/or treatment audit using the network server, in accordance with non-limiting embodiments of the present disclosure.

### DETAILED DESCRIPTION

By way of a brief overview, one embodiment of the present disclosure includes systems and methods for providing information useful for identifying inappropriate pharmaceutical prescription and/or usage, providing reasonable cost estimates for a pharmaceutical, and/or to screen pharmaceuticals in claims, underwriting cost projections, and/or medical appropriateness questions. The systems and methods include a pharmaceutical usage/financial database, and a pharmaceutical clinical and expense module including pharmaceutical search module and optionally clinical filtering module. The pharmaceutical usage/financial database includes data related to pharmaceuticals which may be useful in identifying inappropriate pharmaceutical prescription and/or usage, providing reasonable cost estimates for a pharmaceutical, and/or to screen pharmaceuticals in claims, underwriting cost projections, and/or medical appropriateness questions. The pharmaceutical clinical and expense module (e.g., the pharmaceutical search module and/or clinical filtering module) is configured to receive input data from an authorized client device and search and/or identify potentially relevant data from the pharmaceutical usage/financial database based, at least in part, on the input data.

The input data may include any data useful to identify a pharmaceutical contained in the pharmaceutical usage/financial database (such as, but not limited to, a tradename of a pharmaceutical, a generic name of a pharmaceutical, drug category, and/or drug sub categories), diagnosis data and/or patient data. Diagnosis data may include, but is not limited to, diagnosis codes such as the International Classification of Diseases (ICD) codes published by the World Health Organization (WHO), medical diseases/syndromes, medical signs, medical symptoms, abnormal medical findings, medical complaints, social circumstances, and the like. Patient data may include, but is not limited to, patient age, patient sex, clinical data, location, other medical conditions, genetics, and the like.

The output data identified from the healthcare diagnosis/financial database may include a listing of approved indications associated with the pharmaceutical, a listing of non-approved indications associated with the pharmaceutical, cost information associated with the pharmaceutical, dosage information associated with the pharmaceutical, and/or other medical comments associated with the pharmaceutical. The cost information associated with the pharmaceutical may include Medicare payment information and/or reasonable, free-market costs for the pharmaceutical.

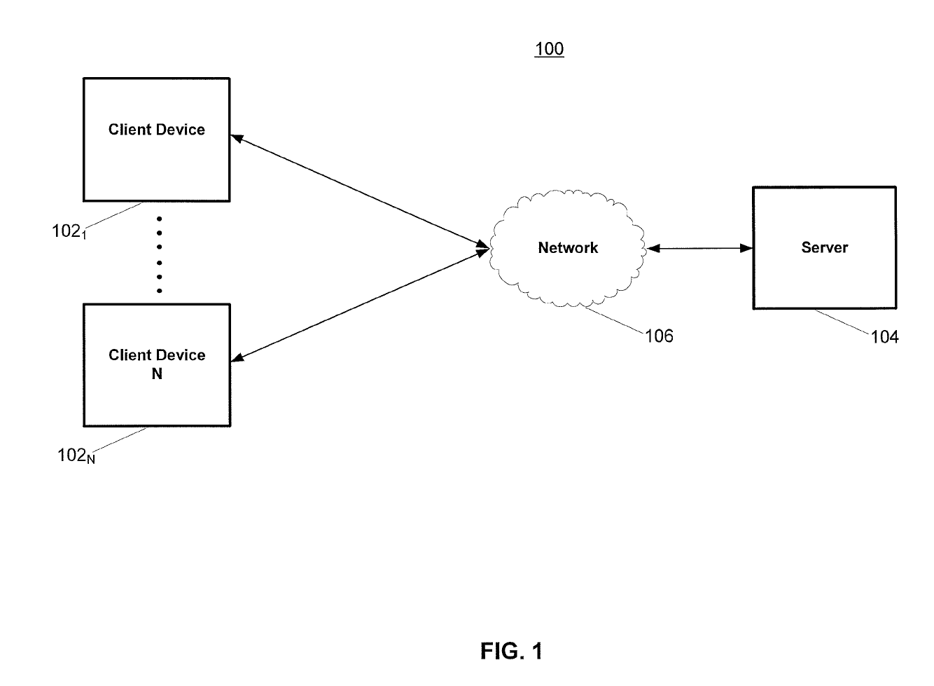

Turning now to FIG. 1, one embodiment of an exemplary system architecture 100 in accordance with non-limiting embodiments of the present disclosure is generally illustrated. As shown, system 100 includes one or more client devices 102₁-102ₙ (individually referred to as a client device 102) and network server 104. Non-limiting examples client devices 102 include mobile devices (such as but not limited to cell phones, electronic readers, handheld game consoles, mobile internet devices, portable media players, personal digital assistants, smart phones, tablet personal computers, ultra-mobile personal computers, netbooks, and notebook computers) as well as desktop computers, kiosks, and public computer terminals.

Client devices 102₁-102ₙ and network server 104 may bi-directionally communicate with one another via network 106. As described herein in more detail, a user may transmit data from a client device 102 via the network 106 to the network server 104. The network server 104 may generate a result which is transmitted via the network 106 to the client device 102. Network 106 may be any network that carries data. As examples of suitable networks that may be used as network 106 in accordance with the present disclosure, non-limiting mention is made of the internet (also referred to herein as the “cloud”), private networks (e.g., a local area network), virtual private networks (VPN), public switch telephone networks (PSTN), integrated services digital networks (ISDN), digital subscriber link networks (DSL), wireless data networks (e.g., cellular phone networks, wireless local area networks, and the like), combinations thereof, and other networks capable of carrying data. In some non-limiting embodiments, network 106 includes at least one of the internet, a local area network, a wireless local area network, a cellular telephone network, and combinations thereof.

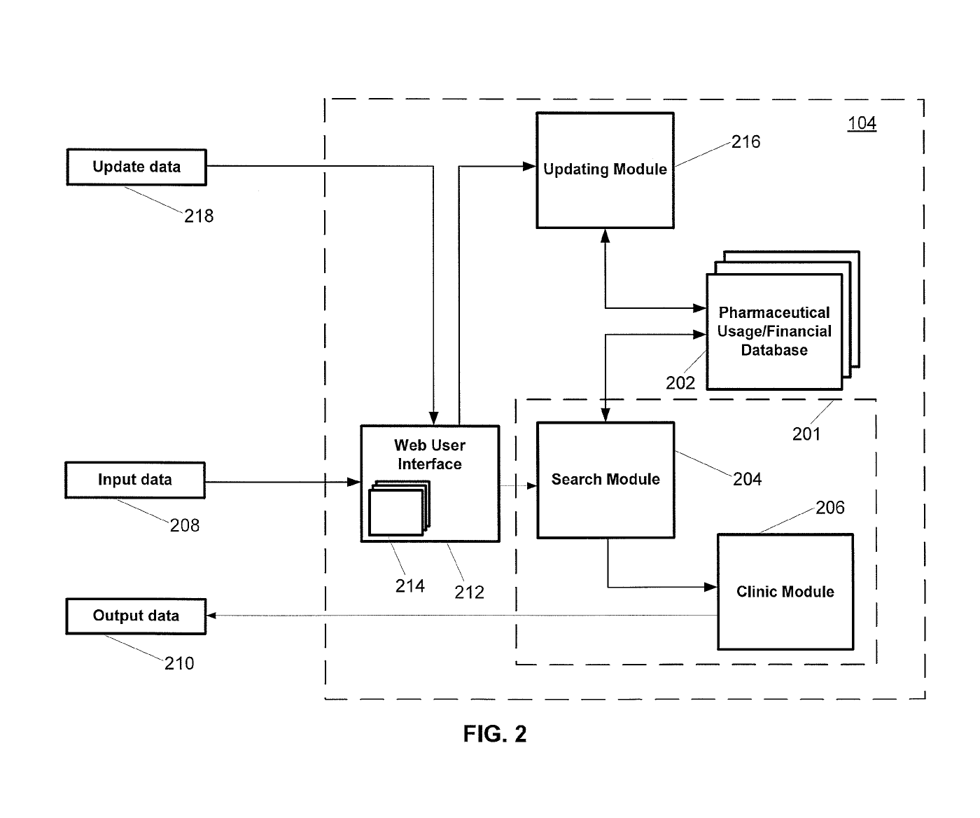

With reference to FIG. 2, one embodiment of an exemplary network server 104 in accordance with non-limiting embodiments of the present disclosure is generally illustrated. For purposes of clarity, the network server 104 is illustrated as a single server machine; however, it should be appreciated that the network server 104 may include a plurality of server machines, which may be co-located or distributed geographically. Additionally, while not illustrated for clarity, network server 104 includes one or more host processors which may execute software, such as but not limited to operating system (OS), modules, and/or applications. Network server 104 also includes chipset circuitry which may include one or more integrated circuit chips. “Circuitry”, as used in any embodiment herein, may comprise, for example, singly or in any combination, hardwired circuitry, programmable circuitry, state machine circuitry, and/or firmware that stores instructions executed by programmable circuitry.

In operation, network server 104 may store a copy or portion of a copy of a pharmaceutical usage/financial database “PUFD” 202. As described in more detail herein, the PUFD 202 includes data related to costly and/or problematic pharmaceuticals which may be useful in as a reference tool for screening expensive pharmaceuticals in medical claims, underwriting costs projections, assessing the validity of charged costs for pharmaceuticals, and medical appropriateness questions related to pharmaceuticals.

Network server 104 may also include one or more modules. For example, network server 104 may include a pharmaceutical clinical and expense module 201. The pharmaceutical clinical and expense module 201 may include a pharmaceutical search module “PSM” 204 and optionally clinical filtering module “CFM” 206. The PSM 204 and/or CFM 206 are configured to receive input data 208 from an authorized client device 102 and search and/or identify potentially relevant data from the PUFD 202 based, at least in part, on the input data 208. The input data 208 may include any data useful to identify a pharmaceutical contained in the PUFD 202. Non-limiting examples of input data 208 may include a tradename of a pharmaceutical, a generic name of a pharmaceutical, drug category, drug sub category 1 and 2, and/or diagnosis data (e.g., but is not limited to, diagnosis codes such as the International Classification of Diseases (ICD) codes published by the World Health Organization (WHO), medical diseases/syndromes, medical signs, medical symptoms, abnormal medical findings, medical complaints, social circumstances, and the like). The input data 208 may optionally include patient data (e.g., but is not limited to, patient age, patient sex, clinical data, location, other medical conditions, genetics, and the like). As explained herein, the potentially relevant output data 210 which may be identified from the PUFD 202 is transmitted to the client device 102. The input data 208 may include, for example, the selection of one or more menus (e.g., but not limited to, drop down boxes) and/or entering data (e.g., but not limited to, typing data).

Network server 104 may further include at least one user interface module “UIM” (e.g., a web user interface) 212. The UIM 212 is configured to receive and verify authentication information from the client device 102 such that only authorized client devices 102 and/or authorized users may gain access to the network server 104. The UIM 212 may include a plurality of user profiles 214. The user profiles 214 contain information used to verify the user's identity, the client device 102, and/or limit access to the network server 104. For example, the user profiles 214 may keep track of and/or limit how many times the user has accessed the network server, which portions of the network server 104 that the user may access, how much data that the user may download, and the like.

The network server 104 may optionally include an updating module “UM” 216. The UM 216 is configured to allow an administrator or authorized user (e.g., but not limited to, a third party vendor) to modify or update selected portions of the network server 104. For example, UM 216 is configured to allow an administrator or authorized user to upload update data 218 to the network server 104. The UM 216 may be configured to grant different rights to different users. For example, the UM 216 may allow the administrator to modify/update any portion of the network server 104 (e.g., data in the PUFD 202, the PSM 204, CFM 206, or the UI 212) while only allowing specific third party vendors to update/modify selected portions of the data contained in the PUFD 202.

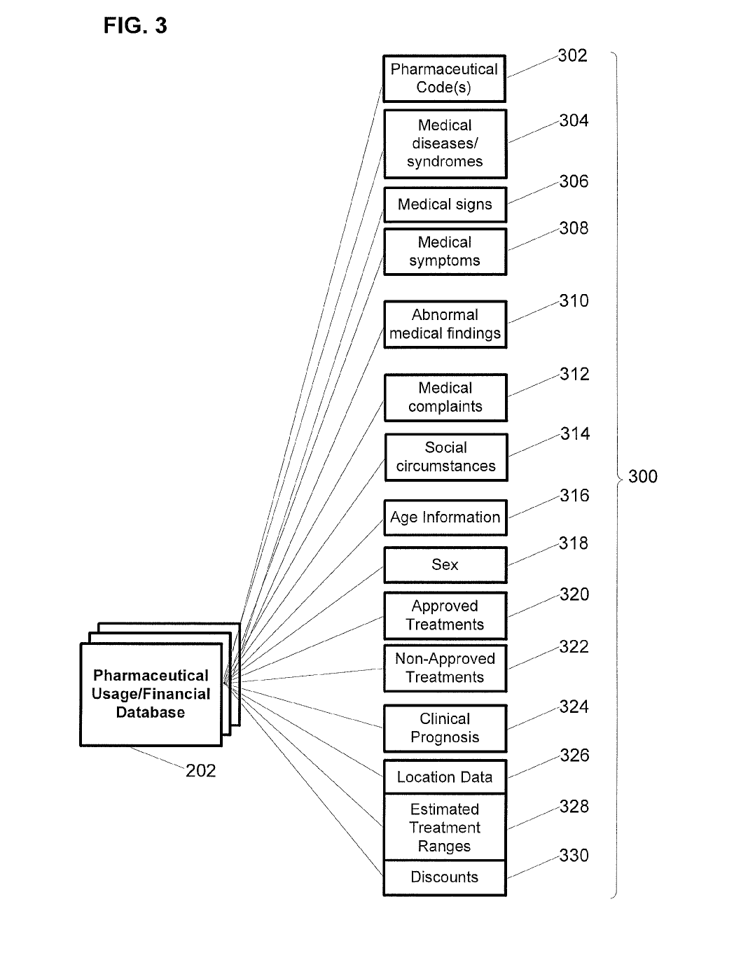

With reference to FIG. 3, one embodiment of an exemplary PUFD 202 in accordance with non-limiting embodiments of the present disclosure is generally illustrated. The PUFD 202 may include data 300 such as, but not limited to, data related to and/or representing pharmaceutical codes 302 (e.g., HCPCS codes), medical diseases/syndromes 304, medical signs 306, medical symptoms 308, abnormal medical findings 310, medical complaints 312, social circumstances 314, age information 316 (e.g., actual age, age ranges, and/or age classifications such as, but not limited to, infant, child, teenager, adult, elderly, etc.), patient sex 318, approved treatments 320 (such as, but not limited to, generally accepted or proven medical treatments (e.g., approved by the U.S. Food and Drug Administration), experimental or non-approved treatments, investigative treatments, alternative treatments) 322, clinical prognosis 324, location data 326 (e.g., regional, local, and/or national), cost information 328, discounts 330 (e.g., regional, local, hospital, and/or national), and the like. The cost information 328 may include, but are not limited to, quantity/dosage information, Medicare payment information/quantity, reasonable free-market cost information, estimated billed amounts, estimated paid amounts, and/or historical data of costs information for some number of claims (e.g., the last X number of claims) received, billed, and/or paid, and optionally including location data (e.g., state). The medical diseases/syndromes 304 may include diagnosis descriptions which can be correlated to a selected pharmaceutical and/or pharmaceutical code. The medical diseases/syndromes 304 may optionally include one or more related codes 302 commonly associated with the pharmaceutical.

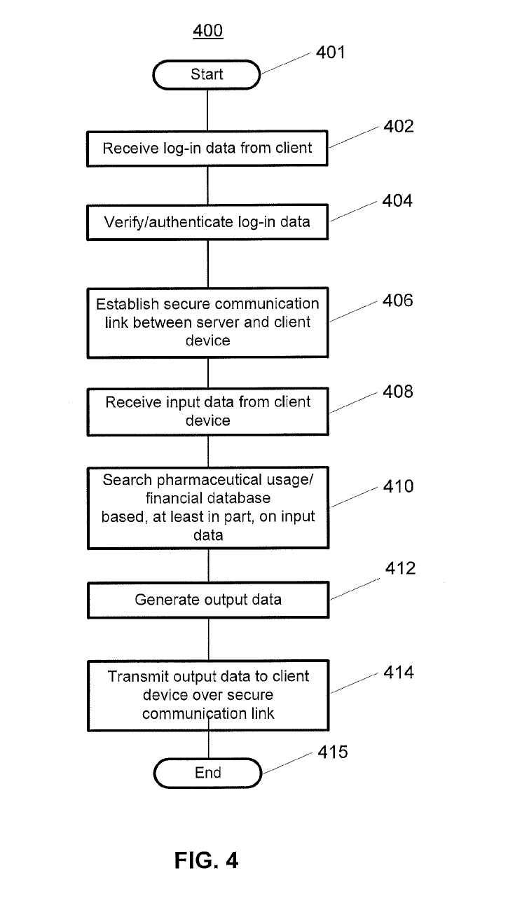

Turning now to FIG. 4, a non-limiting example of a method 400 of providing data to a user at a client device 102 using the network server 104 is generally illustrated. The method starts at block 401. At block 402, log-in data that has been transmitted from a client device 102 is received at the network server 104 via the network 106. The log-in data may include a user identification and password which may be received by the UI 212. At block 404, the UI 212 may verify and/or authenticate the log-in data, for example, by comparing it with the user profiles 214. At block 406, after verification and/or authentication, a secure communication link may optionally be established between the client device 102 and the network server 104 across the network 106. The UI 212 may restrict access to data 300 in the PUFD 202 based on previous use of the network server 104 and the user's account limitations.

At block 408, the network server 104 receives input data 208 from the client device 102. The input data 208 may include any information/data useful to identify a pharmaceutical contained in the PUFD 202. For example, the input data 208 may include a tradename of a pharmaceutical, a generic name of a pharmaceutical, drug category, drug sub category 1 and 2, diagnosis data, and/or patient data (e.g., but is not limited to, patient age, patient sex, clinical data, location, other medical conditions, genetics, and the like).

At block 410, the pharmaceutical clinical and expense module 201 may search the PUFD 202 based, at least in part, on the input data 208 to identify relevant data in the PUFD 202. For example, the PSM 204 may search the PUFD 202 using the input data 208 (e.g., the drug tradename and/or drug generic name) to identify one or more approved indications (e.g., U.S. Food and Drug Administration (FDA) approved indications) and/or off-label uses (e.g., the use of pharmaceutical drugs for an unapproved indication or in an unapproved age group, unapproved dosage, or unapproved form of administration). The approved indications and/or the off-label uses may each include one or more of coding information, cost information, dosing/administration information, and/or physician comments.

Optionally, the CFM 206 may further customize and/or individualize the results of the search of the PUFD 202, for example, based on input data 208. For example, the CFM 206 may utilize the patient data (e.g., patient age, patient sex, clinical data, location, other medical conditions, genetics, etc.) to further specify the approved indication(s), off-label indication(s), clinical assessments, prognosis data, and/or estimated expected reasonable costs. By way of non-limiting examples, the CFM 206 may modify the estimated expected reasonable costs and/or prognosis data based on the patient's location, age, sex, clinical data, and/or medical conditions. For example, the CFM 206 may adjust/modify estimated expected reasonable costs in the PUFD 202 taking into consideration discounts based on the patient's location (e.g., regional discounts, and/or local discounts such as hospital specific discounts). The CFM 206 may adjust/modify estimated expected reasonable costs in the PUFD 202 taking into consideration the patient's clinical data and/or other medical conditions. The CFM 206 may adjust/modify the approved indications, off-label uses, and/or prognosis data based on the patient's age, sex, clinical data, and/or other medical conditions. It may therefore be appreciated that the CFM 206 may customize and/or individualize the results of the search of the PUFD 202 based on how much and the type of input data 208 provided by the client device 102.

At block 412, an output data is generated, for example, by the pharmaceutical clinical and expense module 201. The output may include the data identified from the search of the PUFD 202 as well as additional data. The additional data may include, for example, some or all of the input data 208. At block 414, the network server 104 transmits the output data to the client device 102, for example, over the secure communication link. The user may provide additional input data 208 to the network server 104, and the method 400 may repeat as necessary. The method then ends at block 415.

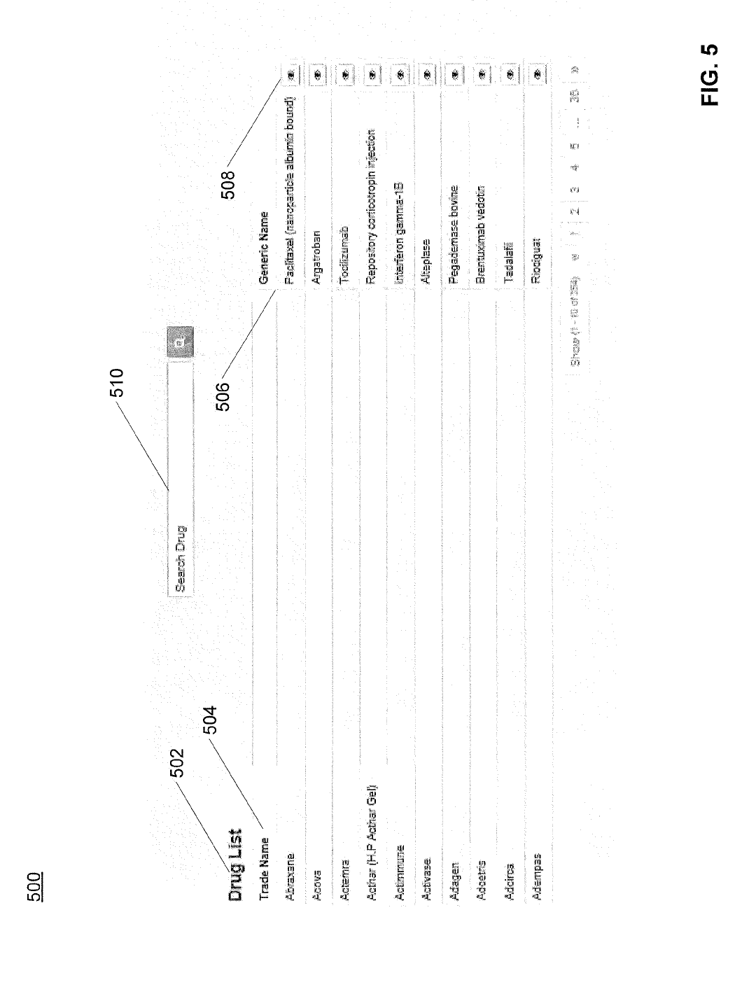

Turning now to FIG. 5, a non-limiting example of an exemplary user interface 500 is generally illustrated. The user interface 500 may include a pharmaceutical drug list section 502 including a pharmaceutical trade name set 504 and/or a generic pharmaceutical name set 506. The pharmaceutical trade name set 504 may include a plurality of pharmaceuticals associated with the PUFD 202 listed by the pharmaceutical trade name whereas the generic pharmaceutical name set 506 may include a plurality of pharmaceuticals associated with the PUFD 202 listed by the generic pharmaceutical name. The pharmaceutical drug list section 502 may optionally include a selector 508 associated with the pharmaceutical trade name set 504 and/or the generic pharmaceutical name set 506 that allows a user to select the desired pharmaceutical. The user interface 500 may also optionally include a search box and/or drop down menu 510. The search box and/or drop down menu 510 may allow a user to enter in additional input data such as, but not limited to, drug category, drug sub category 1 and 2, diagnosis data (e.g., but is not limited to, diagnosis codes such as the International Classification of Diseases (ICD) codes published by the World Health Organization (WHO), medical diseases/syndromes, medical signs, medical symptoms, abnormal medical findings, medical complaints, social circumstances, and the like), and/or patient data (e.g., but is not limited to, patient age, patient sex, clinical data, location, other medical conditions, genetics, and the like) which may be used to search the PUFD 202 to identify one or more potentially relevant pharmaceuticals.

It should be appreciated that the user interface 500 illustrated in FIG. 5 is merely one example consistent with the present disclosure. The format and content of the user interface provided by the network server 104 may depend on the input data 208 provided to the network server 104 by the user at the client device 102. As such, the user interface may not always include all of the information illustrated in FIG. 5 and/or may include additional or alternative information.

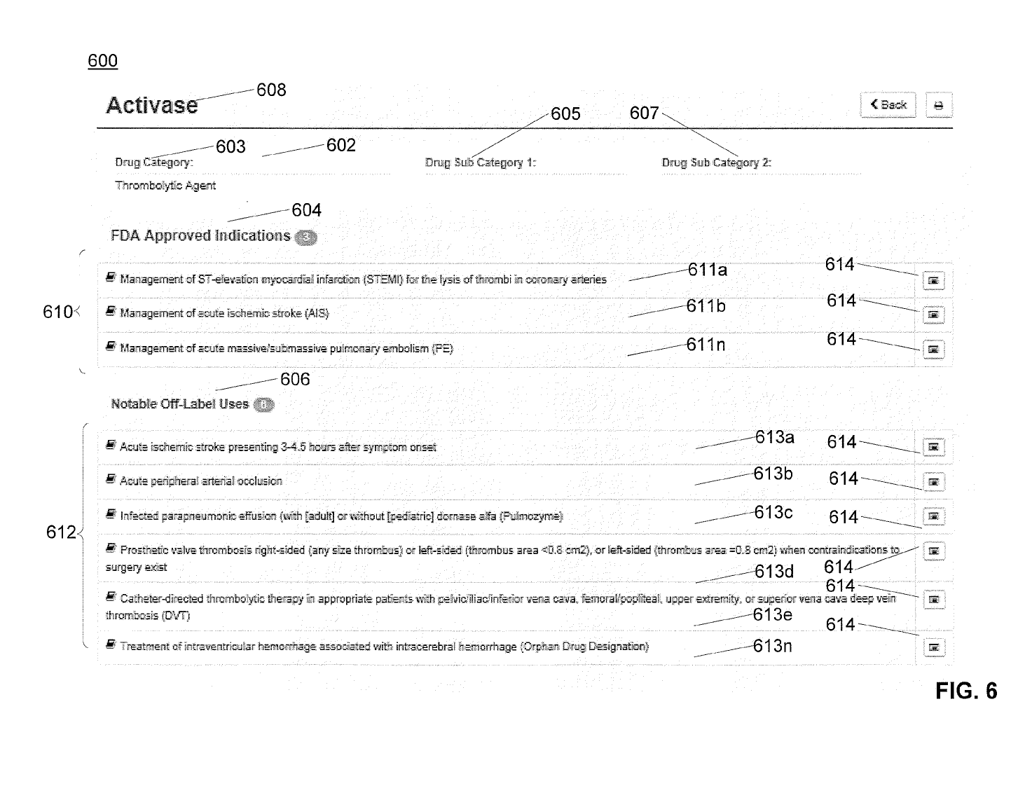

With reference to FIG. 6, a non-limiting example of an exemplary output data 600 generated by the network server 104 which may be transmitted to and received at a client device 102 for an identified/selected pharmaceutical 608 listed in the PUFD 202 is generally illustrated. The output data 600 may include drug category and/or sub category data 602, approved indication data 604 associated with the identified/selected pharmaceutical 608 and/or off-label usage data 606 associated with the identified/selected pharmaceutical 608. The drug category and/or sub category data 602 may include data related to the classification of the identified/selected pharmaceutical 608, for example, as determined the manufacturer and/or the U.S. FDA. For example, the drug category and/or sub category data 602 may include the drug category 603, drug sub category 1 605, and/or drug sub category 2 607.

The approved indication data 604 may include a listing 610 of one or more indications 611a-611n for which the identified/selected pharmaceutical 608 has been approved, for example, by the U.S. FDA. The off-label usage data 606 may include a listing 612 of one or more unapproved indications 613a-613n or in an unapproved age groups, unapproved dosages, or unapproved forms of administration for the identified/selected pharmaceutical 608. The user may select one of the approved indications 611a-611n and/or off-label indications 613a-613n from the listings 610, 612, for example, using a selector 614.

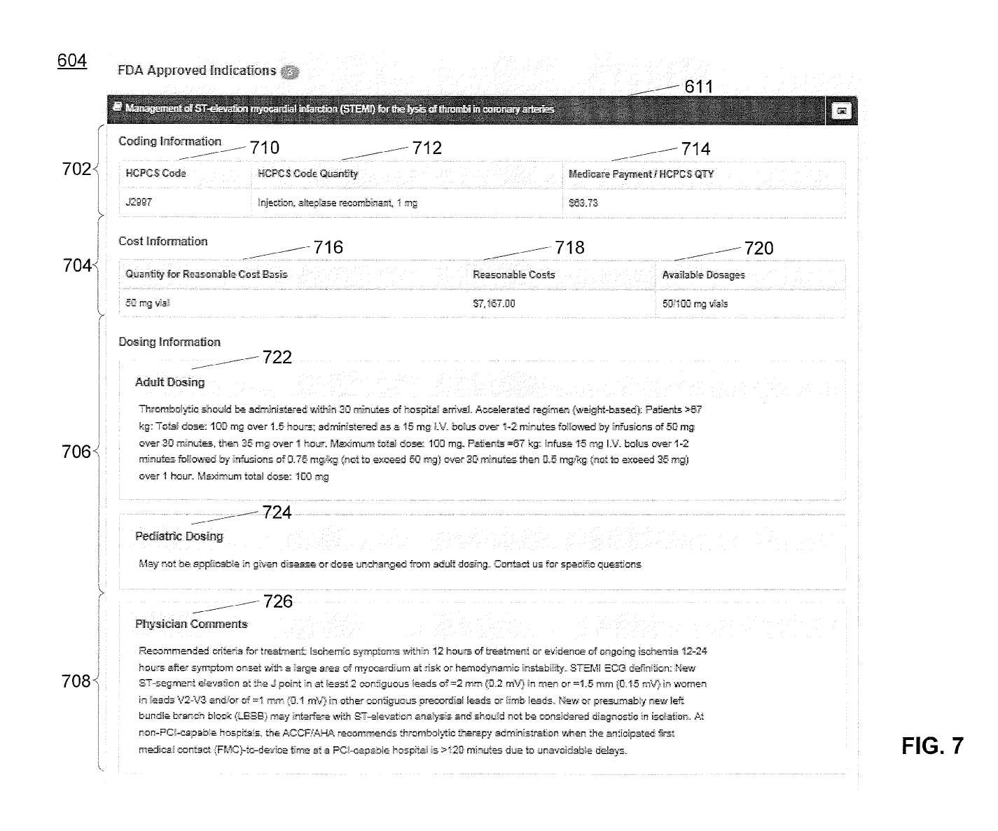

Turning now to FIG. 7, one embodiment of the approved indication data 604 for a selected indicator 611 is generally illustrated in more detail. The approved indication data 604 may include coding information 702, reasonable cost information 704, dosing information 706, and/or medical comments 708. The coding information 704 may include, for example, any coding information useful for (and/or any information related to) the identification, administration, and/or billing of the selected pharmaceutical 608 and/or selected indicator 611. For example, the coding information may include one or more codes 710 (e.g., but not limited to, a Healthcare Common Procedure Coding System number (HCPCS Code) developed by the American Medical Association), administration information 712 (e.g., but not limited to, HCPCS Code quantities and administration information), and/or billing and/or cost information 714 (e.g., but not limited to, Medicare payment information/quantity).

The reasonable cost information 704 may include information related to the reasonable costs and quantities (e.g., dosages) are for the selected pharmaceutical 608 when used for a particular FDA approved indicator 611. The reasonable costs are calculated and determined based on a free market calculation for the selected pharmaceutical 608 when used for a particular FDA approved indicator 611. For example, the reasonable cost information 704 may include information related to the quantity for the reasonable costs basis 716, the reasonable, free market costs 718 for the indentified quantity basis 716 of the selected pharmaceutical 608, and/or information related to other available dosages 720.

The free market costs 718 for the selected pharmaceutical 608 may optionally include national free market cost information which may be based on a cost amount and/or a cost range of national cost information which is derived from real-world costs. The free market costs 718 for the selected pharmaceutical 608 may also optionally include customized, adjusted, and/or filtered cost information which may be based on a cost amount and/or cost range taking into consideration patient data 208. By way of a non-limiting example, the customized, adjusted, and/or filtered expected cost information may include local cost information. The local cost information may be based on regional and/or local geographical data (e.g., the local cost information may take into consideration which state, zip code, and/or whether the patient will be having treatment in the northeast, Massachusetts, greater Boston area, specific hospital or hospital system, and/or insurance provider). The customized, adjusted, and/or filtered expected treatment cost information may also include discount information (e.g., which may be based on the patient's geography and/or other medical conditions).

Additionally, the user may select one or more networks and/or preferred provider organization (PPO) for which he/she is interested in obtaining estimated expected costs. For example, the user may enter geographical data (e.g., but not limited to, a state and/or a zip code) as described above. Based on the entered geographical data, a listing of available networks and/or PPOs may be provided to the user. The listing of available networks and/or PPOs may also include an Average Other Networks in order to provide the user with additional information regarding how the costs associated with the other selected networks and/or PPOs compare to the average of the other networks.

The user may then select one or more networks and/or PPOs which are of interest from the listing of available networks and/or PPOs. The user may optionally enter a search term to identify one or more networks and/or PPOs from the listing. The selected networks and/or PPOs may then be shown in a listing of networks and/or PPOs. The estimated expected costs may include estimated expected costs for the listing of selected networks and/or PPOs which are of interest. For example, the estimated expected treatment costs may include an estimated, expected cost and/or range of estimated, expected costs for each of the selected networks and/or PPOs in the listing.

The dosing information 706 may include information related to the appropriate dosing for the selected pharmaceutical 608 for the selected FDA approved indicator 611. The dosing information 706 may filtered and/or customized based on the input data 208 (e.g., but not limited to, the patient's age, sex, and/or other medical conditions). For example, the dosing information 706 may include adult dosing instructions 722 and/or pediatric dosing instructions 724.

The medical comments 708 may include information 726 related to the appropriate use of the selected pharmaceutical 608. The information 726 may optionally include special issues and/or circumstances associated with the selected pharmaceutical 608 that may be useful determining the appropriateness of the selected pharmaceutical 608 for the selected FDA approved indicator 611. For example, the special issues and/or circumstances information may include information related to potential complications and/or interactions of the selected pharmaceutical 608 with other treatments and/or procedures. The information may also relate to up-and-coming uses of the selected pharmaceutical 608 (e.g., potential uses of the selected pharmaceutical 608 other medical conditions).

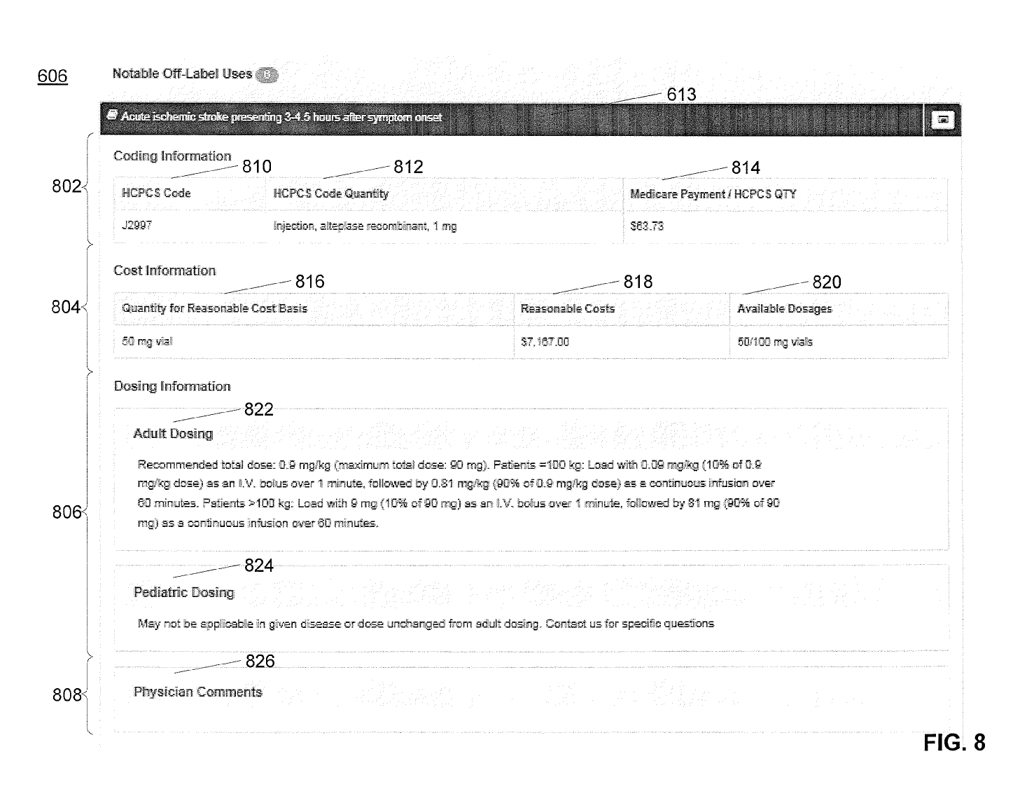

Turning now to FIG. 8, one embodiment of the off-label usage or non-approved indication data 604 for a selected indicator 613 is generally illustrated in more detail. The unapproved indications data 606 may include coding information 802, reasonable cost information 804, dosing information 806, and/or medical comments 808. The coding information 804 may include, for example, any coding information useful for (and/or any information related to) the identification, administration, and/or billing of the selected pharmaceutical 608 and/or selected indicator 613. For example, the coding information may include one or more codes 810 (e.g., but not limited to, HCPCS Code), administration information 812 (e.g., but not limited to, HCPCS Code quantities and administration information), and/or billing information 814 (e.g., but not limited to, Medicare payment information/quantity).

The reasonable cost information 804 may include information related to the reasonable costs and quantities (e.g., dosages) are for the selected pharmaceutical 608 when used for the unapproved indicator 613. The reasonable costs are calculated and determined based on a free market calculation for the selected pharmaceutical 608 when used for the unapproved indicator 613. For example, the reasonable cost information 804 may include information related to the quantity for the reasonable costs basis 816, the reasonable, free market costs 818 for the indentified quantity basis 816, and/or information related to other available dosages 820.

The free market costs 818 for the selected pharmaceutical 608 may optionally include national free market cost information which may be based on a cost amount and/or a cost range of national cost information which is derived from real-world costs. The free market costs 818 for the selected pharmaceutical 608 may also optionally include customized, adjusted, and/or filtered cost information which may be based on a cost amount and/or cost range taking into consideration patient data 208. By way of a non-limiting example, the customized, adjusted, and/or filtered expected cost information may include local cost information. The local cost information may be based on regional and/or local geographical data (e.g., the local cost information may take into consideration which state, zip code, and/or whether the patient will be having treatment in the northeast, Massachusetts, greater Boston area, specific hospital or hospital system, and/or insurance provider). The customized, adjusted, and/or filtered expected treatment cost information may also include discount information (e.g., which may be based on the patient's geography and/or other medical conditions).

Additionally, the user may select one or more networks and/or preferred provider organization (PPO) for which he/she is interested in obtaining estimated expected costs. For example, the user may enter geographical data (e.g., but not limited to, a state and/or a zip code) as described above. Based on the entered geographical data, a listing of available networks and/or PPOs may be provided to the user. The listing of available networks and/or PPOs may also include an Average Other Networks in order to provide the user with additional information regarding how the costs associated with the other selected networks and/or PPOs compare to the average of the other networks.

The user may then select one or more networks and/or PPOs which are of interest from the listing of available networks and/or PPOs. The user may optionally enter a search term to identify one or more networks and/or PPOs from the listing. The selected networks and/or PPOs may then be shown in a listing of networks and/or PPOs. The estimated expected costs may include estimated expected costs for the listing of selected networks and/or PPOs which are of interest. For example, the estimated expected treatment costs may include an estimated, expected cost and/or range of estimated, expected costs for each of the selected networks and/or PPOs in the listing.

The dosing information 806 may include information related to the appropriate dosing for the selected pharmaceutical 608 for the selected unapproved indicator 613. The dosing information 806 may filtered and/or customized based on the input data 208 (e.g., but not limited to, the patient's age, sex, and/or other medical conditions). For example, the dosing information 806 may include adult dosing instructions 822 and/or pediatric dosing instructions 824.

The medical comments 808 may include information 826 related to the appropriate use of the selected pharmaceutical 608. The information 826 may optionally include special issues and/or circumstances associated with the selected pharmaceutical 608 that may be useful determining the appropriateness of the selected pharmaceutical 608 for the selected unapproved indicator 613. For example, the special issues and/or circumstances information may include information related to potential complications and/or interactions of the selected pharmaceutical 608 with other treatments and/or procedures. The information may also relate to up-and-coming uses of the selected pharmaceutical 608 (e.g., potential uses of the selected pharmaceutical 608 other medical conditions).

It should be appreciated that the output data illustrated in FIGS. 6-8 is merely one example consistent with the present disclosure. The format and content of the data provided by the network server 104 will depend on the input data 208 provided to the network server 104 by the user at the client device 102. As such, the output data may not always include all of the information illustrated in FIGS. 6-8 and/or may include additional or alternative information.

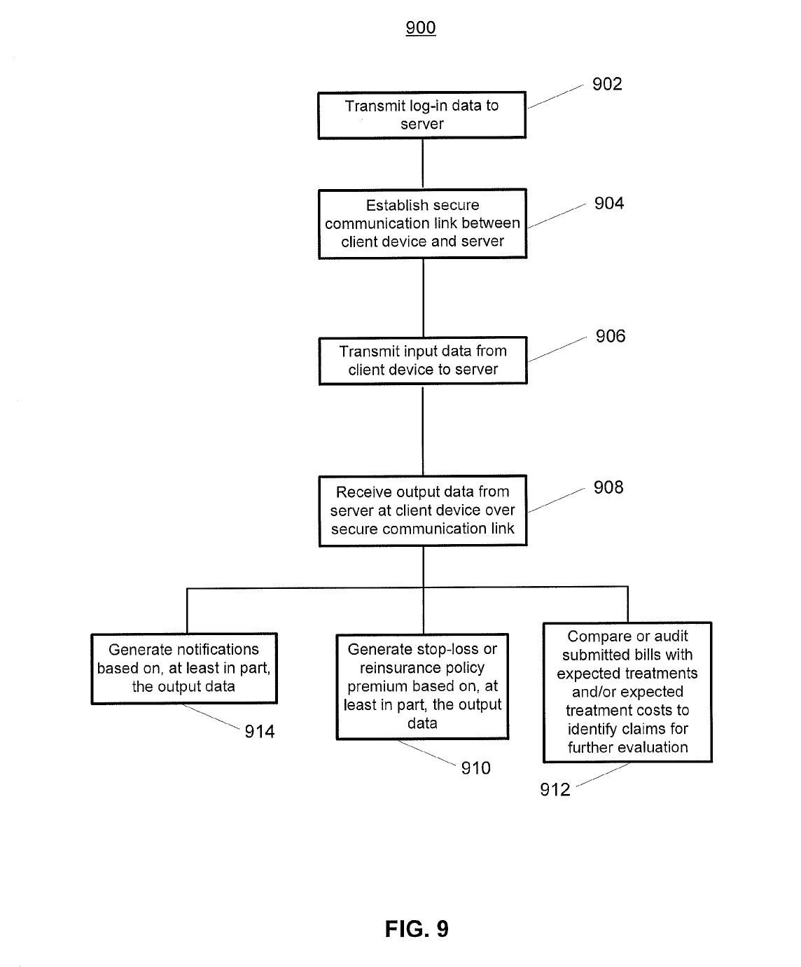

With reference to FIG. 9, a non-limiting example of a method 900 of obtaining data at a client device 102 to obtain information regarding a prescribed or potentially prescribed pharmaceutical using the network server 104 is generally illustrated. At block 902, the method 900 includes transmitting log-in data from the client device 102 to the network server 104 across network 106. Optionally, a secure communication link may be established between the client device 102 and the network server 104 at block 904. After the network server 104 verifies and/or authenticates the user and/or client device 102, the user transmits input data 208 from the client device 102 to the network server 104 at block 906. The user may provide only data necessary to identify the pharmaceutical in question (e.g., but not limited to, the trade name of the pharmaceutical, the generic name of the pharmaceutical, drug category of the pharmaceutical, drug subcategorie(s) of the pharmaceutical, HCPCS code of the pharmaceutical, and/or diagnosis). The user may also provide patient data (e.g., but not limited to, the patient's age, sex, medical condition, and/or clinical data). Upon receipt of the input data 208, the network server may search the PUFD 202 to identify potentially relevant information related to the input data 208 (e.g., drug category and/or sub category data 602, approved indication data 604 associated with the identified/selected pharmaceutical 608 and/or off-label usage data 606 associated with the identified/selected pharmaceutical 608).

At block 908, the client device 102 may receive output data from the network server 104, for example, across the secure communication link. An example of the output data received at the client device 102 may include the output data as generally illustrated in FIGS. 6-8. The data received from the network server 104 may be used, at least in part, to identify inappropriate pharmaceutical, provide reasonable cost estimates for the pharmaceutical, and/or to screen pharmaceuticals in claims, underwriting cost projections, and/or medical appropriateness questions.

At block 912, the data received from the network server 104 may be used, at least in part, to analyze, compare, and/or audit a submitted bill. By way of non-limiting example, the actual and/or to be prescribed pharmaceutical 608 and/or costs of the pharmaceutical 608 may be compared with a data associated with approved indication data 604 and/or off-label usage data 606. Actual and/or to be prescribed pharmaceutical 608 uses which are not included in the approved indication data 604 and/or off-label usage data 606 may be rejected and/or flagged for further examination/investigation. Additionally (or alternatively), the costs associated with actual and/or to be prescribed pharmaceutical 608 may be compared with the estimated reasonable costs 704, 804 associated with the identified pharmaceutical 608 to determine if they are appropriate and/or reasonable. For example, costs associated with actual and/or to be prescribed pharmaceutical 608 which do not fall within the range of estimated reasonable costs 704, 804 associated with the identified pharmaceutical 608 may be rejected and/or flagged for further examination/investigation.

At block 914, the data received from the network server 104 may be used, at least in part, to generate one or more notifications. By way of non-limiting example, the output data may be used to generate reservation notifications, cost containment notifications, and/or management opportunity notifications. Notification may be generated, for example, upon a pharmaceutical code (e.g., HCPCS code) being entered, for example, into the network server 104 and/or the user's system.

The user of the network server 104 may include, but is not limited to, insurance companies, worker compensation agencies, third party insurance administers, stop loss companies, Taft Hartley plans, and the like.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination as would be understood by one skilled in the art. Thus, not all of the operations of each of the flowcharts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk re-writables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry,” as used in any embodiment herein, may comprise, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Other embodiments of the present disclosure will be apparent to those skilled in the art from consideration of the specification and practice of the inventions disclosed herein. It is intended that the specification be considered as exemplary only, with a true scope and spirit of the invention being indicated by the following claims.

What is claimed is:

1. A method of generating for determining appropriateness of a pharmaceutical prescription, said method comprising:
receiving, at a remote server, input data from a client device, said input data comprising at least one of a tradename of a pharmaceutical, a generic name of said pharmaceutical, drug category, drug sub category, or diagnosis data;
searching, using a pharmaceutical clinical and expense module, a pharmaceutical usage/financial database (PUFD) to identify relevant data based on said input data;
generating, using said pharmaceutical clinical and expense module, output data based, at least in part, on said identified relevant data; and
transmitting said output data to said client device.

2. The method of claim 1, wherein said input includes patient data, said patient data comprising at least one of patient age, patient sex, clinical data, geographic location, other medical conditions, or genetics.

3. The method of claim 1, wherein said input includes diagnosis data, said diagnosis data comprising at least one of a diagnosis code, medical diseases, medical symptoms, medical signs, abnormal medical findings, medical complaints, or social circumstances.

4. The method of claim 1, further comprising verifying and authenticating, using a user interface module, at least one of said client device or a user of said client device.

5. The method of claim 4, further comprising establishing a secure connection between said remote server and said client device.

6. The method of claim 1, wherein generating said output data comprises at least one of a listing of at least one approved indicator associated with a pharmaceutical or a listing of at least one non-approved indicator associated with said pharmaceutical.

7. The method of claim 1, wherein said listing of at least one approved indicator associated with a pharmaceutical or said listing of at least one non-approved indicator associated with said pharmaceutical is modified based, at least in part, on patient data or diagnosis data.

8. The method of claim 7, wherein said patient data comprises at least one of patient age, patient sex, clinical data, geographic location, other medical conditions, or genetics.

9. The method of claim 7, wherein said input diagnosis data comprises at least one of a diagnosis code, medical diseases, medical symptoms, medical signs, abnormal medical findings, medical complaints, or social circumstances.

10. The method of claim 6, wherein said listing of at least one non-approved indicator associated with said pharmaceutical includes at least one off-label indicators.

11. The method of claim 6, wherein said output data comprises said listing of at least one approved indicator associated with said pharmaceutical, wherein at least one of said approved indicators comprises at least one of coding information for identifying or billing said pharmaceutical, cost information associated with said pharmaceutical, dosing information associated with said pharmaceutical, or medical comments associated with said pharmaceutical.

12. The method of claim 11, wherein said cost information associated with said pharmaceutical includes cost information on a dosage basis when used for the approved indicator.

13. The method of claim 11, wherein said cost information associated with said pharmaceutical includes at least one of national cost information or local geographically specific cost information.

14. The method of claim 11, wherein said cost information associated with said pharmaceutical is based, at least in part, on a selected insurance network.

15. The method of claim 11, wherein said dosing information associated with said pharmaceutical is based, at least in part, on patient data, said patient data comprising at least one of patient age, patient sex, clinical data, geographic location, other medical conditions, or genetics.

16. The method of claim 11, wherein said medical comments associated with said pharmaceutical includes at least one of information related to potential complications or interactions of said pharmaceutical with other treatments or procedures, or potential uses of said pharmaceutical for other medical conditions.

17. The method of claim 1, wherein generating said output data further comprises customizing said output data based on, at least in part, said input data.

18. The method of claim 1, wherein receiving, at said remote server, input data from said client device comprises at least one of selecting said pharmaceutical from a list of pharmaceuticals.

19. The method of claim 6, wherein said output data comprises both said listing of at least one approved indicator and said listing of at least one non-approved indicator associated with said pharmaceutical.

20. The method of claim 6, wherein said output data comprises said listing of at least one non-approved indicator associated with said pharmaceutical, wherein at least one of said non-approved indicators comprises at least one of coding information for identifying or billing said pharmaceutical, cost information associated with said pharmaceutical, dosing information associated with said pharmaceutical, or medical comments associated with said pharmaceutical.
